(19) United States
(12) Patent Application Publication
(10) Pub. No.: US 2003/0088514 A1
(43) Pub. Date: May 8, 2003

(54) Automated teller machine check printing

(76) Inventor: Robert Sesek, Meridian, ID (US)

Correspondence Address: HEWLETT-PACKARD COMPANY, Intellectual Property Administration, P.O. Box 272400, Fort Collins, CO, 80527-2400, US

(21) Appl. No.: 10/008,007

(22) Filed: Nov. 8, 2001

(51) Int. Cl. G06F 17/60

(52) U.S. Cl. 705/43

(57) ABSTRACT

A check drafted upon an account with a financial institution is generated from an ATM interface. A unique identifier is discovered for the account. Either the unique identifier or account information encoded on a magnetic strip is read. If the account information is read, the unique identifier is retrieved from a database of account information. Authorization to draft the check on the account is verified. A destination printer is identified for printed the check. An electronic representation of the check is formatted for the destination printer. The electronic representation of the check includes a check template and the unique identifier for the account. The electronic representation of the check is sent to the destination printer. The electronic representation of the check is printed from the destination printer.

### FIELD OF THE INVENTION

This invention relates in general to automated teller machines and, more particularly, to check printing from automated teller machines.

### BACKGROUND OF THE INVENTION

Although credit card acceptance by retailers is quite high, a small number of retail establishments do not accept credit cards. The customer must pay with either cash or a check. Often the reason these retailers do not accept credit cards is that the financial institution backing the credit card receives a percentage of each credit card transaction, thereby reducing the profit of the retailer. This reduction in profit may cause those retailers that have very low profit margins to lose money on purchases paid for with credit cards.

Automated teller machines (ATMs) have become commonplace within the last decade or two. ATMs allow a customer of a financial institution to obtain cash nearly everywhere.

Typically the customer inserts a bank card into the ATM. The bank card has customer information magnetically encoded on a magnetic strip on the card. A card reader within the ATM reads the customer information from the card and prompts the customer for a personal identification number (PIN). The customer enters the PIN on an interface of the ATM. Together, the bank card and the PIN are used to establish the identity of the customer and to verify that the customer is authorized to access the customer's financial account. Biometric identification provides an alternative to either the bank card, the PIN, or both the bank card and the PIN for authorizing the customer to access the account.

Once properly authorized, the customer may make certain limited financial transactions through the ATM interface. For example, the customer may obtain cash, deposit cash or checks, or receive a printed statement of the customer's account balance. Usually, a transaction fee is assessed against the customer's account for each of these transactions.

Conventional ATMs provide one solution for obtaining funds to make purchases at retailers that only accept cash or checks. One drawback of obtaining cash at ATMs and making purchases with the cash is the difficulty of tracking purchases made with cash. Purchases made with checks are listed on a checking account statement provided by the customer's financial institution.

The conventional alternative to paying in cash is carrying a check or checkbook whenever making purchases at a retailer that only accepts cash or checks. This solution has drawbacks as well. Many people are unwilling or unable to carry a checkbook with them on a regular basis. Additionally, many people do not know exactly how much money they have in their checking account. Therefore, it is possible for the customer to write a check without having sufficient funds in the checking account to cover the amount of the check. Often fees are assessed against the customer by the bank and the retailer for writing a check with insufficient funds available in the account to cover the amount of the check.

### SUMMARY OF THE INVENTION

According to principles of the present invention, a check drafted upon an account with a financial institution is generated from an ATM interface. A unique identifier is discovered for the account. Authorization to draft the check on the account is verified. A destination printer is identified for printing the check. An electronic representation of the check is formatted for the destination printer. The electronic representation of the check includes a check template and the unique identifier for the account. The electronic representation of the check is sent to the destination printer. The electronic representation of the check is printed on the destination printer.

According to further principles of the present invention, either the unique identifier or account information encoded on a magnetic strip is read. If the account information is read, the unique identifier is retrieved from a database of account information.

### DESCRIPTION OF THE DRAWINGS

FIG. 1 is a block diagram representing one embodiment of the system of the present invention for generating a check drafted upon an account with a financial institution.

FIG. 2 is a flow chart illustrating one embodiment of the method of the present invention for generating a check drafted upon an account with a financial institution.

### DETAILED DESCRIPTION OF THE INVENTION

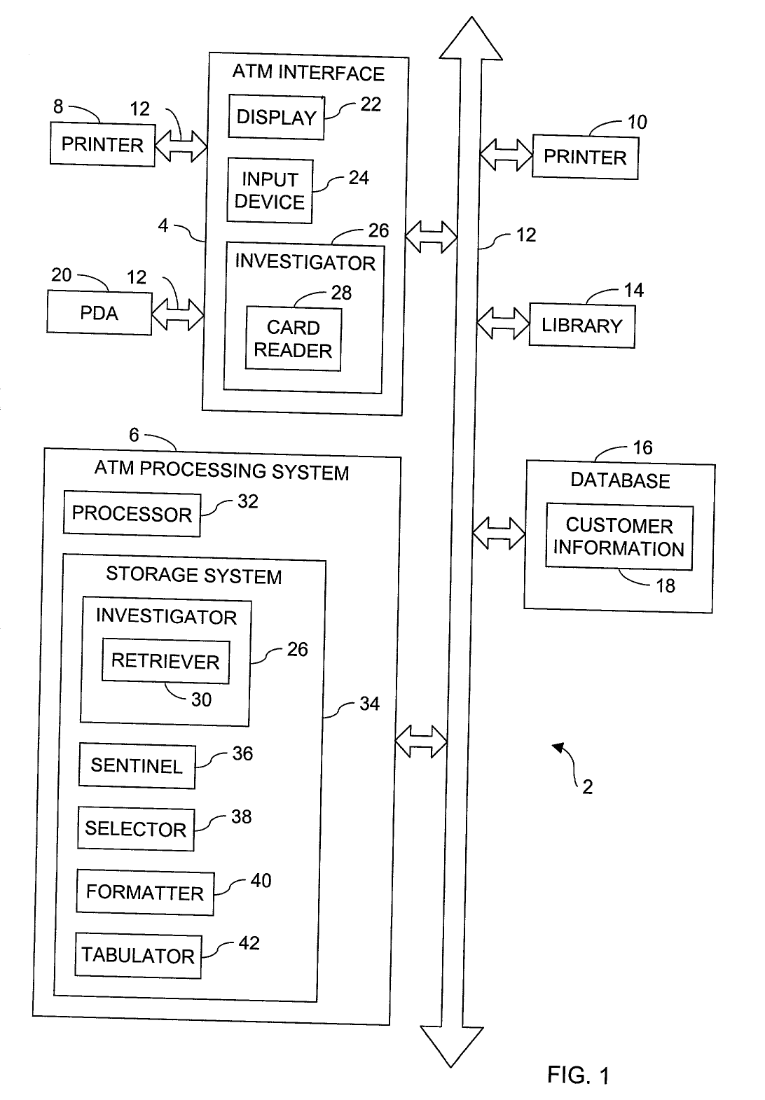

Illustrated in FIG. 1 is one embodiment of a system 2 for generating a check drafted upon an account with a financial institution. System 2 includes an automated teller machine (ATM) interface 4, an ATM processing system 6, at least one destination printer 8, 10, and a communication system 12. Optionally, system 2 further includes a template library 14, a database 16 of customer information 18, and a personal data assistant (PDA) 20.

ATM interface 4 is any combination of hardware and executable code configured to allow a user to selectively input a check amount, a check payee, and a date for the check. ATM interface 4 includes a display 22, an input device 24, and an investigator 26. Display 22 is any device or system configured to display information or menu queries to a customer. Input device 24 is any device or system configured to provide input to ATM interface 4. Examples of input device 24 include a touch screen and a keyboard. Alternatively, PDA 20 provides an input to ATM interface 4.

Investigator 26 is any combination of hardware and executable code configured to discover a unique identifier for the account. In one embodiment, investigator 26 includes a magnetic strip reader 28. Magnetic strip reader 28 is any combination of hardware and executable code configured to read a magnetic strip to obtain a unique identifier for the account. In an alternate embodiment, investigator 26 includes magnetic strip reader 28 and retriever 30. Magnetic strip reader 28 is any combination of hardware and executable code configured to read account information encoded on the magnetic strip. Retriever 30 is any combination of hardware and software configured to retrieve the unique identifier from database 16 of account information 18. In still another embodiment, investigator 26 includes a biometric authentication device (not shown). The biometric authentication device is any combination of hardware and executable code configured to uniquely identify a person.

ATM processing system 6 is any device or system configured to process information and perform executable code for the present invention. ATM processing system 6 is shown in FIG. 1 as a device separate from ATM interface 4. Alternatively, ATM processor 6 is embodied within the same device as ATM interface 4. ATM processing system 6 includes processor 32 and storage system 34.

Processor 32 is any device or system configured to process executable code. Processor 32 controls ATM processing system 6.

Storage system 34 is any system configured to store data or executable code. Storage system 34 may also be a program storage system tangibly embodying a program, applet, or instructions executable by processor 32 for performing the method steps of the present invention executable by processor 32. Storage system 34 may be any type of storage media such as magnetic, optical, or electronic storage media. Storage system 34 is illustrated in FIG. 1 as a single device. Alternatively, storage system 34 may include a plurality of devices. Furthermore, each device of storage system 34 may be embodied in a different media type. For example, one device of storage system 34 may be a magnetic storage media while another device of storage system 34 is an electronic storage media.

ATM processing system 6 further includes investigator 26, sentinel 36, selector 38, formatter 40, and tabulator 42. In one embodiment, investigator 26, sentinel 36, selector 38, formatter 40, and tabulator 42 are stored on storage system 34.

Sentinel 36 is any combination of hardware and executable code configured to verify authorization to draft a check on the account. Selector 38 is any combination of hardware and executable code configured to identify the destination printer 8, 10. Formatter 40 is any combination of hardware and executable code configured to format an electronic representation of the check for the destination printer. The electronic representation of the check includes a check template and the unique identifier for the account. In one embodiment, the electronic representation of the check further includes one or more of a unique identifier for the check, the input amount, payee, additional notes, and date for the check. Tabulator 42 is any combination of hardware and executable code configured to confirm the amount of the check does not exceed a balance of the account.

Destination printers 8, 10 are any system or device configured to print the check. In one embodiment, the check is printed onto a blank page. In an alternate embodiment, the check is printed to a check blank.

Communication system 12 is any system configured to send the electronic representation of the check to the destination printer 8, 10 and providing communication between ATM interface 4 and PDA 20.

Template library 14 is any combination of hardware and executable code configured to customize the check template before formatting the electronic representation of the check. In one embodiment, template library 14 is embodied on storage system 34. In an alternate embodiment, template library is accessible by ATM processing system 6 through communication system 12.

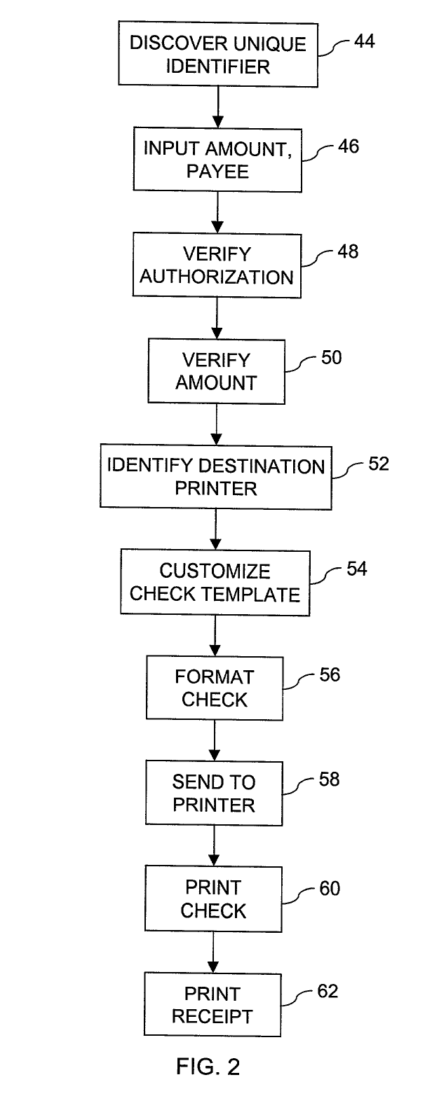

FIG. 2 is a flow chart representing steps of one embodiment of the present invention. Although the steps represented in FIG. 2 are presented in a specific order, the present invention encompasses variations in the order of steps. Furthermore, additional steps may be executed between the steps illustrated in FIG. 2 without departing from the scope of the present invention.

A unique identifier is discovered 44 for the account. The unique identifier includes a bank routing number and a customer account number. In one embodiment, the unique identifier is read from the information encoded on a magnetic strip. In an alternative embodiment, the account information encoded on a magnetic strip is read and the unique identifier is retrieved from a database of customer account information for the account. Examples of customer account information includes customer name, customer address, Driver's license number, social security number, telephone number, account #, account balance, available credit.

Optionally, an amount of the check, a payee of the check, a date of the check, a custom or standard check template, a check number, a personal notation, or any combination of these are selectively input 46. If not entered, this information is left blank.

Authorization to draft the check on the account is verified 48. Without verification 48 of authorization, the check is not printed.

If the amount of the check is entered, the amount of the check is, optionally, confirmed 50 not to exceed a balance of the account. Confirming the balance helps prevent overdrafts on the account. If desirable, a credit line may be extended to cover checks in excess of the account balance.

A destination printer 8, 10 is identified 52 configured to print the check.

The check template is optionally customized 54 before formatting the electronic representation of the check. The check template is customized 54 by using installed templates or downloading template to ATM processing system 6.

An electronic representation of the check is formatted 56 for the destination printer. The electronic representation of the check including a check template and the unique identifier for the account.

The electronic representation of the check is sent 58 to the destination printer 8, 10. The electronic representation of the check is printed 60 from the destination printer.

Optionally a receipt is printed 62 to destination printer 8, 10 or another printer selected by the user.

Optionally if a PDA 20 is in communication with ATM interface 4, an electronic transmission of data to PDA 20 could balance a checkbook on PDA 20.

The foregoing description is only illustrative of the invention. Various alternatives and modifications can be devised by those skilled in the art without departing from the invention. Accordingly, the present invention embraces all such alternatives, modifications, and variances that fall within the scope of the appended claims.

What is claimed is:

1. A method for generating a check drafted upon an account with a financial institution, the method comprising:
(a) discovering a unique identifier for the account;
(b) verifying authorization to draft the check on the account;
(c) identifying a destination printer for printing the check;
(d) formatting an electronic representation of the check for the destination printer, the electronic representation of the check including a check template and the unique identifier for the account; and,
(e) sending the electronic representation of the check to the destination printer.

2. The method of claim I wherein discovering the unique identifier includes reading the unique identifier from information encoded on a magnetic strip.

3. The method of claim I wherein discovering the unique identifier includes:
(a) reading account information encoded on a magnetic strip; and,
(b) retrieving the unique identifier from a database of account information.

4. The method of claim I further including selectively inputting an amount, a payee, and a date for the check and wherein the electronic representation of the check further includes the input amount, payee, and date for the check.

5. The method of claim 4 further including confirming the amount of the check does not exceed a balance of the account.

6. The method of claim 1 further including customizing the check template before formatting the electronic representation of the check.

7. The method of claim 1 further including printing the electronic representation of the check from the destination printer.

8. A system for generating a check drafted upon an account with a financial institution, the system comprising:
(a) an investigator configured to discover a unique identifier for the account;
(b) a sentinel configured to verify authorization to draft the check on the account;
(c) a destination printer configured to print the check;
(d) a selector configured to identify the destination printer;
(e) a formatter configured to format an electronic representation of the check for the destination printer, the electronic representation of the check including a check template and the unique identifier for the account; and
(f) a communication system configured to send the electronic representation of the check to the destination printer.

9. The system of claim 8 wherein the investigator includes a magnetic strip reader configured to read the unique identifier from information encoded on a magnetic strip.

10. The system of claim 8 wherein the investigator includes:
(a) a magnetic strip reader configured to read account information encoded on a magnetic strip; and,
(b) a retriever configured to retrieve the unique identifier from a database of account information.

11. The system of claim 8 further including an automated teller machine interface configured to selectively allow input of an amount, a payee, and a date for the check and wherein the electronic representation of the check further includes the input amount, payee, and date for the check.

12. The system of claim 11 further including a tabulator configured to confirm the amount of the check does not exceed a balance of the account.

13. The system of claim 8 further including a template library configured to customize the check template before formatting the electronic representation of the check.

14. A program storage system readable by a computer, tangibly embodying a program, applet, or instructions executable by the computer to perform method steps for generating a check drafted upon an account with a financial institution, the method steps comprising:
(a) discovering a unique identifier for the account;
(b) verifying authorization to draft the check on the account;
(c) identifying a destination printer for printing the check;
(d) formatting an electronic representation of the check for the destination printer, the electronic representation of the check including a check template and the unique identifier for the account; and,
(e) sending the electronic representation of the check to the destination printer.

15. The program storage system of claim 14 wherein the method step of discovering the unique identifier includes reading the unique identifier from information encoded on a magnetic strip.

16. The program storage system of claim 14 wherein the method step of discovering the unique identifier includes:
(a) reading account information encoded on a magnetic strip; and,
(b) retrieving the unique identifier from a database of account information.

17. The program storage system of claim 14 wherein the method steps further include selectively inputting an amount, a payee, and a date for the check and wherein the electronic representation of the check further includes the input amount, payee, and date for the check.

18. The program storage system of claim 17 wherein the method steps further include confirming the amount of the check does not exceed a balance of the account.

19. The program storage system of claim 14 wherein the method steps further include customizing the check template before formatting the electronic representation of the check.

20. The program storage system of claim 14 wherein the method steps further include printing the electronic representation of the check from the destination printer.
